(19) United States
(12) Patent Application Publication
(10) Pub. No.: US 2015/0235179 A1
(43) Pub. Date: Aug. 20, 2015

(54) Self-Directed Career Management System

(71) Applicants: Kyle Levon Schmidt, Sacramento, CA (US); William Clark, Lodi, CA (US)

(72) Inventors: Kyle Levon Schmidt, Sacramento, CA (US); William Clark, Lodi, CA (US)

(21) Appl. No.: 14/183,408

(22) Filed: Feb. 18, 2014

(51) Int. Cl. G06Q 10/10; H04L 29/06; G06F 17/30

(52) U.S. Cl. CPC G06Q 10/1053; G06F 17/30339; H04L 63/083; G06F 17/30011

(57) ABSTRACT

This invention, the Self-Directed Career Management System, is a web application enabling job seekers in one or more occupational categories to connect to a server via the internet from a client computer with a web browser. Once connected, they can create a user account permitting them to input, view, edit and delete all data and documents required by any employer in making hiring decisions. Once the data is entered, the user can then direct the system to send documents such as resumes and applications in a variety of formats, such as PDF, Microsoft Word, and XML to specified recipients.

### BACKGROUND

1. The Field of the Present System

The present system relates to automated means of improving efficiency of job seeking and hiring.

2. Description of the Related Art

Over the past decade or so, the personal computer, internet, and the World Wide Web have combined to enhance the efficiency and speed with which job-seekers and employers can connect to one another, and to enhance the numbers of contacts between the two over larger geographical areas.

While enhancing the old system, the use of these technologies merely emulates the age-old process of job hunting/hiring. Job seekers must still submit resumes and applications to EACH employer or hiring agent. Job seekers must maintain stores of all data relating to their professional skills and qualifications on a home computer or old fashioned filing system of hard copy records. Modern systems still require them to submit resumes and applications in different formats to different employers. Additionally, once hired the new employee must complete standard employment documentation such as tax forms and, in certain professions, must complete standard competency examinations. Again, these documents become the property of the employer. Once entered into these systems, the data typically is not retrievable by the user who entered it—he loses access to it and it is no longer his.

The dominant trend in talent acquisition based on the new technology has been for employers, including supplemental (temporary and contract) staffing agencies, to utilize applicant tracking system (ATS) software to mange their talent acquisition needs. The vast majority of these applicant tracking systems are unique to the specific employer and typically require that applicants create a user account, and/or complete an “on-line job application” (typically differing greatly from one employer to another) in order to even be considered for a job opening with the respective employer. The applicant tracking systems are intended to make the hiring and human resource processes more efficient and organized for the employer, but do nothing for the applicant. Applicant tracking systems have disadvantages for both applicants and employers. Applicants often must complete a high volume of on line applications. In addition, they must keep track of numerous user names and passwords. They may also be required to complete industry standard documents multiple times duplicating their efforts. As a result, applicants, especially those currently employed and often referred to as “passive candidates,” often abandon the job application process altogether.

This results in inefficiencies in the overall labor market which represent a disadvantage for employers. Application abandonment is a particularly pronounced problem in the supplemental staffing industry where staffing agencies must quickly submit employment application packets for job openings that are urgent and quickly filled. Additionally, application fatigue reduces the speed with which job seekers conduct their job searches. Furthermore, many applicant tracking systems lack the capability to provide employers with all of the details they require to conduct a thorough review and screening of the applicant prior to moving forward in the hiring process. Combined, these factors can potentially increase the prevalence of some forms of frictional unemployment.

Meanwhile, current alternatives to applicant tracking systems such as internet based job boards and internet based professional networking services also lack the capability to provide employers with all of the details they require to conduct a thorough review and screening of the applicant.

### SUMMARY

The present invention is a system and method of self-directed collecting, storing, organizing, displaying, and distributing information relevant to hiring, employment, and career management. For the purpose of this patent application, the invention will be referred to as the “self-directed career management system” or simply SDCMS. The term, self-directed, means that the person to whom the information stored in the system pertains is the owner of the information and has complete control over it.

The gist of this invention is that it provides a network connected server with a central information store. The information store is designed to accommodate information relevant to one or more sets of job titles or occupations in a particular occupational category or type. Users of client computers with access to the network server can connect to it to create unique accounts. With an account, a connected, logged in and authenticated user can then input new information, or view/edit/delete existing information pertaining ONLY to their account. The information store is ideally designed to store all information needed by any prospective employers to hire the person associated with the account. Additionally, the server provides connected, authenticated clients with an interface permitting ONLY them to select from a list one of a number of preformatted document file(s) for download to their client device from where the documents can be printed or distributed as the user desires. These preformatted documents comprise resumes, employment applications, tax forms, standard exams, and other employment related documentation, and computer readable documents (which permit recipients to receive the information and format it as they see fit importing it into existing application tracking systems or other software).

### BRIEF DESCRIPTION OF THE DRAWINGS

FIG. 1 illustrates the Self-Directed Career Management System and represents the preferred embodiment of the invention.

FIG. 2 illustrates the preferred embodiment of the data store of the Self-Directed Career Management System.

FIG. 3 illustrates the data store manager of an SDCMS.

FIG. 4 illustrates the document store manager of an SDCMS.

FIG. 5 illustrates the account manager of the Self-Directed Career Management System.

FIG. 6 illustrates the login handler action of the account manager of FIG. 5.

FIG. 7 illustrates the registration handler action of the account manager of FIG. 5.

FIG. 8 illustrates the output manager of the SDCMS.

### DETAILED DESCRIPTION

In brief, The Self-Directed Career Management System in its preferred embodiment is a web application on server computer(s) enabling users of client computers a means of setting up unique user accounts, and then inputting, editing, and deleting data or documents relating to one or more occupations or types or categories of occupations into a centralized data or document store on the server(s), and to download to the client computer or electronically transmit to electronic transmission destinations, such as email addresses, FTP sites, etc., formatted reports containing one or multiple portions of their stored data for forwarding to prospective employers, hiring agents or others. A key feature of the system is that only those persons who know the username and identifying data (password or other) to a user account can access via a client computer any of the data or documents associated with the account for creating, reading, updating, deleting, or distributing account data or documents. The data store and document store are therefore private to each user account and under the control of the user account.

It was stated above that an SDCMS is designed to apply to one or more occupations or types or categories of occupations. It is to be understood that an SDCMS could be developed for occupations A, and a separate one for occupations B, thus forming two separate SDCMS web applications. But is also to be understood that an SDCMS for occupations A and occupations B can also be combined into one web application comprising two separate and independent SCDMS's each accessible via a menu selection. A single web application thus can be comprised of multiple SDCMS's, each pertaining to a different occupation or category of related occupations, for example, nursing and allied professions, architects, electronics engineer, physicist, astronomy and related professions.

The reasons that implementing SDCMS as a web application is the preferred embodiment are that first, nearly all computers purchased these days have web browser software already installed on them which can access the SDCMS by merely requesting the SDCMS web site main page, second, said computers are ready to connect to the internet via a service provider and most users already have such service up and running, third, a web application on a server constitutes a single central copy of the application software that can be quickly and easily updated, and fourth, a number of web application development frameworks exist which make development of such an embodiment easier.

Developing embodiments of this invention that are not web applications is certainly feasible. Those skilled in the art will recognize that any database server used in conjunction with any FTP server connected to the internet or an intranet could be used in conjunction with a client computer software program (instead of a web browser) to access the data store can be developed to perform all the functions of the preferred embodiment. Such an embodiment, while feasible, would not be preferred because it requires the user to install software most users do not already have, and said software is more difficult and costly to update across all client computers instead of in one centralized location. Nevertheless, such an embodiment would indeed qualify as an SDCMS, though not employing HTTP and HTML or other web technologies.

The developers of an embodiment of SDCMS ideally would strive to achieve satisfying any prospective employer's need or desire for data presented in a format acceptable to them. If this ideal is met by an SDCMS, it could be said to be perfect in this respect. It should be noted, however, that there is no intent to imply in the description or definition of this invention any defining amount or proportion of data and formats that must be included for an embodiment to constitute an SDCMS. How close or far from the ideal has nothing to do with whether it is an SDCMS or not. The only requirement is report generation in one or more formats of career relevant data such as resumes, employment applications, tax forms, standard examinations, etc.

To develop a preferred embodiment of this invention as a web application requires selecting and installing one of the general purpose, full stack web application development frameworks, such as ASP.NET, Catalyst, Mojolicious, Ruby on Rails, Django, Zend Framework, Yii, CakePHP, or Symfony on an appropriate development computer with any one of the operating systems that the framework will run on. Alternatively, one may build from scratch his own full stack web application framework and use it to build an SDCMS. Once the selected framework is installed on the development computer, an appropriate choice of integrated web application development environments (IDE's), such as Netbeans or Eclipse, needs to be obtained and installed on the development computer. The Self-Directed Career Management System can now be developed and tested and subsequently migrated to an identically configured server on a hosting service of choice.

A full stack web application development framework for creating an SDCMS comprises an HTTP server program (such as Apache, Microsoft IIS, or other), a programming language (such as PHP, Ruby, Perl or Python, or other), a database management system (such as Oracle, SyBase, MySQL, or other), and a preferred embodiment would include also a pre programmed framework (such as Ruby on Rails, Zend Framework, Symphony or any other) programmed in the language decided on for use in a full stack framework. Additionally, one or more programmatic digital document generators are required. These are all software components which must be installed on one or more computers and configured to work together upon connecting to the internet. Many full stack web development frameworks can be obtained by download from a number of web sites which include all the components and an installation program which will configure these components on a single computer.

Web application frameworks can be quite different from each other depending on the “software patterns” they employ. A number of different patterns exist such as MVC (model-view-controller), active-record-pattern, and ORM (object relational mapping). MVC frameworks can be push (action) based or pull (view) based, or both. Learning to develop a web application in any of the frameworks, and there are dozens, is difficult and time consuming and not for the faint of heart. But once a developer or group of developers and programmers gets the hang of a particular framework, web application development time can be reasonably fast. In fact, that's why they were developed. Terminologies or “what things are called” varies considerably from one framework to another, and there are many server side programming languages involved. This makes it more difficult to explain how to build an SDCMS in terms that can be used by anyone skilled in any one of the frameworks to develop the SDCMS in that framework.

Fortunately, all the frameworks have a common purpose—to make applications on the World Wide Web. All those who are adept at developing a web application in any framework are fully familiar with HTTP and HTML, the foundations of the web. All web application frameworks are designed to provide functionalities for easing the task of developing web applications. The following terms and definitions are given for the purpose of providing a “framework” of terms and concepts applicable to all the web application frameworks so that one who is knowledgeable of any one of them will be able to develop an SDCMS in that framework without undue experimentation.

In the HTTP client/server model the client sends an HTTP request to the server and the server responds by returning a response. The request typically identifies a file on the server and the response returned is typically the file requested or a file generated by the file requested. HTTP comprises a set of methods named GET, POST, PUT, DELETE, HEAD and others. An SDCMS may be built entirely using only a GET request and a POST request, but others may be used if desired and where appropriate. All frameworks meeting the requirements for an SDCMS are designed to automatically intercept all client requests arriving at the HTTP server. All frameworks are designed with many preprogrammed capabilities which occur automatically allowing the user to intervene at certain points to develop the code needed to develop the essentials of the application. That's why they are called frameworks. All frameworks are designed to provide the following functionalities to a programmer familiar with the language of the framework:

Predispatcher: A means of performing predispatch HTTP request action(s). In developing an SDCMS this functionality is needed to implement SDCMS security, the function of the SDCMS account manager. The fundamental role of the account manager is to use the predispatcher to examine each request received from a client to set up client tracking and to identify the client as authenticated or not authenticated and take appropriate action, such as redirecting an unauthenticated user to the login page whenever a request for a page requiring authentication is received, and allowing authenticated client requests to pass through to the dispatcher.
Client tracking: A means of identifying a client computer from which a request is received. This typically involves sending a session cookie to the client when a request without one is received. Browsers will send cookie information back to the server with each request if one has been assigned. Included in the session cookie is a unique value (string, hexadecimal number, etc.) called a session id so that the server can maintain data about the client between requests. Server frameworks and the programming languages they are made of provide for creating a session class on the server containing the same session id value placed in the session cookie. The session class generally permits a programmer to store information about the user, such as whether or not he has been authenticated by successfully completing the login process. The unique user account id distinguishing each user account from all others, can also be included in the session object.
Cryptograhic hashing: A means of deriving a message authentication code (MAC) which uniquely identifies any arbitrary block of data. All frameworks and the languages used to build them provide one or more functions to which a block of data can be passed, for example the encrypted value of the session id and other data included in a session cookie. The encryption of the data prevents other users from viewing the data without decrypting it. Sending the encrypted data to a hash function generates a unique MAC which can be saved in the session cookie's corresponding session object on the server. When the cookie is later returned via a client request, the encrypted data can be sent to the hashing function again to get its MAC which can be compared to the MAC saved in the session object and if they match it constitutes verification of the cookie. An SDCMS should employ the means here to safeguard cookie information and to guarantee via MAC's that they have not been tampered with.
Dispatcher: A means of dispatching a request to its handler: A dispatcher, also called a router, examines the HTTP request to determine what software routine (developed by the developer in accordance with instructions on how to use the framework) to pass program execution to initiate the handling of the request. Frameworks often provide a predefined or pre programmed system requiring users to define handler actions in a class module, often called a controller, and the programmer decides on the name for the controller and names each handler action he creates as he sees fit in the controller using a naming convention provided by the framework. Thus, if a programmer creates a controller named Education and creates methods in the class named read, edit, delete then if a client types www.sdcms.org/education/read in his browser address bar, the framework will automatically turn this request over to the read method in the Education controller. Frameworks differ regarding the software classes and naming conventions used to achieve proper routing.
Access control: a means for associating every valid request URL from a client to a handler action on the server and of associating every handler action with a value (True or False, for example) indicating whether authentication is required for a client to be sent a response. Above it was stated that frameworks provide a predefined means of corresponding request URLs to handler actions. Frameworks also provide means for a programmer to devise a module of their own and a means of intervening on the dispatcher to instruct it to use the module to conduct custom routing and in this module the programmer decides on the URL names (such as “/foo/bar” for example) and associate them with a controller of their own name (Mycontroller, for example), and a handler action (myroutine, for example). The user of the client must type “www.sdcms.org/foo/bar” for the framework to send the request to the myroutine routine in the Mycontroller controller. The programmer can thus define what URL's the web application will contain (for example “/education/read”, or “/public/contactus”, etc. and associates each URL with a handler action, and whether or not authentication is required by the client submitting the request. To do this the programmer must follow instructions provided in the framework.
Handler action: A means of handling a request: The request handler, also called request processor, or action, is where we will frequently be accessing the SDCMS data store or document store to perform database CRUD (create, read, update, and delete operations on records in the data store, and to perform similar operations (adding new, deleting existing, or updating data pertaining to documents in the document store). These handlers represent the starting point of the data store and document store managers and the output manager.
Redirector: A means of redirection: All frameworks provide a means whereby a programmer can at various points in the framework invoke or call (turn program execution over to) a different request handler causing the client to be sent a different web page from the one requested. This capability will be exploited in SDCMS during the predispatch action—an unauthenticated client, for example, may request a web page requiring authentication and be redirected to the login page from which he may also register for a user account. Also, some actions, like deleting a record by clicking a “Delete” link will cause the request to be routed to a delete record handler which when complete directs the user back to the page from which he clicked the hyperlink.
A means of attaching parameters to requests: This is native to HTTP requests. A programmer can attach name-value pairs, strings, numbers, etc. to the end of a URL. This feature is used extensively by SDCMS. For example, if a user has requested to read the records belonging to his account from a data store table, the programmer can generate a page putting “Edit” and “Delete” hyperlinks next to each record and can programmatically append the record id number as a parameter to each hyperlink URL. When the user clicks on a link, the request sent to the edit and delete actions will inform the action which record to present back to the user for editing, or which record to delete and then redirect back to the page where the hyperlinks were located.
Post validator: A means of validating POST inputs from clients in response to submission of HTML form elements: All frameworks provide fairly sophisticated means for validating client POST requests. One can implement SDCMS without validating user input, but this is not advised. A POST request will end up being routed to an appropriate handler or controller action and this is where validation should occur. A very common practice is to program the handler to pass error messages to be printed in red next to the input element containing the error and then generating the same page back to the client with the errors and his original values for correction, or if no errors are detected, save the input values to the appropriate fields of the appropriate record of the appropriate table. Frameworks differ in terms of the preprogrammed code modules permitting input validation but also permit customization methods.
Response generator: A means of generating HTML documents: All frameworks provide this in some form or another as that's what the web is all about—clients send requests, and the server sends responses, and the response is typically an HTML document, or web page. Most frameworks are preprogrammed so that the request handler turns program execution automatically over to the response generator when the programmer is finished, unless of course the programmer redirects elsewhere. It is typically in the handler action that the programmer must pass data to the response generator. The response generator will receive any data (table record field values for example) needed to generate the document. What all this achieves is called server side dynamic web page generation, without which there would be no web applications, and this is fundamental to all frameworks. Typically a response generator is simply a file containing both HTML code, the language of the web, and code in the framework's language (PHP, PERL, or whatever). Framework languages are abundant with capabilities for manipulating HTML. In essence one is using one language to write text in another language.
Data passer: A means of passing data. Different frameworks do this differently, but there is a means provided to the handler action of assigning data to a variable, usually in a “class” object associated with or accessible to the response generator.

The above definitions of the functionalities in all frameworks provide the skeleton needed to accomplish all the programming functionalities needed for an SDCMS in any web application framework meeting the criteria. What are those functionalities? A set of interrelated software systems programmed using the framework's language. They include the account manager, data and document stores, data store manager, document store manager, and the output manager, which makes use of the programmatic digital document generator(s) not yet discussed.

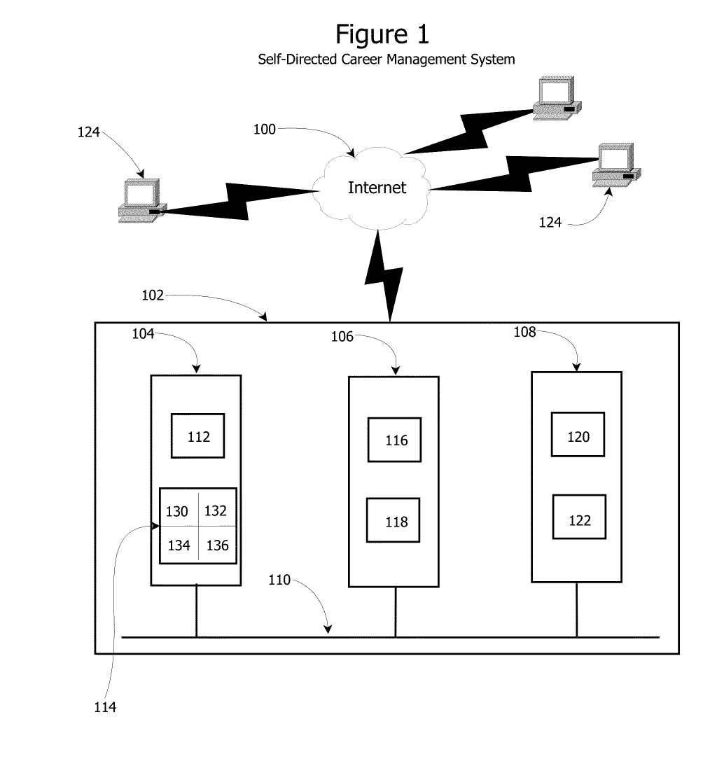

In its preferred embodiment, the Self-Directed Career Management System is one or more computers in a networked system of interconnected computers such as that shown in FIG. 1. FIG. 1 depicts an SDCMS 102 connected to the Internet 100. Client computing devices 124 with web browser software installed and connected to the internet can access the SDCMS 102 via its main URL. Self-Directed Career Management System 102 is comprised of component 104, comprising a web server 112, which could be one of a number of web server software packages such as Apache or Microsoft IIS, and SDCMS Software 114, software programmed in any full stack web application development framework. Component 106 comprises a database management system 116 and database 118. Component 108 comprises a means to access files 120 and a file storage device 122. Components 104, 106, and 108 could all be located on a single computer. Or 104 could be on one computer and 106 and 108 on a second computer. Or 104, 106, and 108 could each be on separate computers. In general, any combination of one or more of 104, 106, and 108 on the same or different computers will work. If all components are located on a single computer and configured to work together, component 110 would be the single computer's system bus permitting data transfers between all components. If two or more computers are involved, then 110 would be the network interface (which could be the internet itself) through which connected computers can transfer data. If 108 is located on a computer separate from 104, then component 120 (a means to access files) could be, for example, FTP server software, but if on the same computer, the operating systems filing system software provides the interface to access files on the computers file storage media (disk drives, etc.).

The process whereby a client 124 sends an HTTP request to an SDCMS and how the SCDMS prepares the response is now briefly outlined. Users access the Self-Directed Career Management System 102 via computing devices 124, which can be personal computer, wireless devices such as cell phones, or any other device capable of connecting to the Internet 100 and configured with internal web browsers. Note that all communications between client and SDCMS occur via web (HTTP) server component 112 either by the user at the client clicking a hyperlink or entering a valid URL in the web browser address bar. The SDCMS software 114 is comprised of the account manager 130, the data store manager 132, the document store manager 134, and the output manager 136. All incoming requests from the HTTP server are first processed by the account manager 130. The account manager makes sure that the client request is from a verified unauthenticated or authenticated user and if so, dispatches the request to the appropriate manager (data store manager 132, document store manager 134, or output manager 136). A typical request will be sent to a handler action uniquely associated with the request. This function typically accesses the data store 118 through the database management system 116 or the document store 122 through its interface 120 for viewing, editing or deleting a database table record, or for uploading, downloading, or deleting a file. If from the data store 118 the data is then passed to a software module, a response generator, which is programmed to prepare an HTML document (web page) incorporating the data, if any, and sending it back to the client via the HTTP server 112 as the HTTP response to the client HTTP request. Alternatively, if the request pertains to uploading, downloading or deleting document files, SDCMS software account manager 130 forwards the request to a function in the document store manager 134 uniquely associated with the request programmed to upload, download or delete the file on storage media 122 via the means to access 120 said media.

While the Self-Directed Career Management System is described here as being executed on an Internet or intranet 100, it will be understood by those skilled in the art that the software could be executed entirely or in part via local or wide area networks of all types, as well as hosted entirely on user personal computers, wireless devices, or other devices capable of running software and storing data.

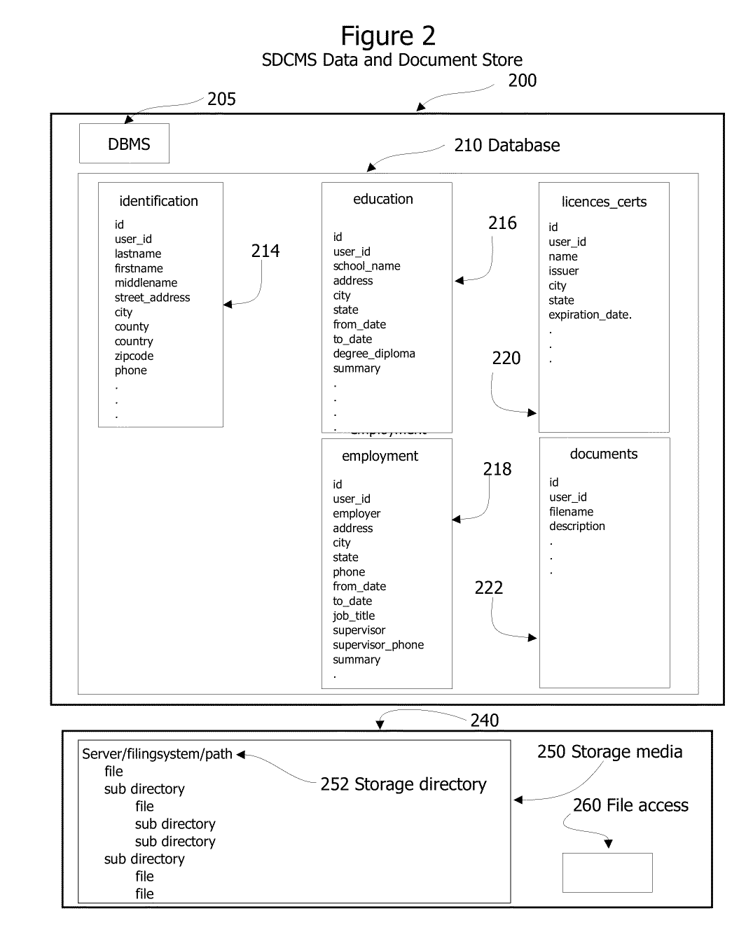

Now the data store and document store of an SDCMS are described. For purposes of illustration only, it is assumed that the SDCMS being implemented is for the nursing and allied professions occupational category. FIG. 2 Illustrates the preferred embodiment of the data store and document store components of the Self-Directed Career Management System. Data store 200 and document store 240 are representations of data store 106 and document store 108 from FIG. 1. The data store 200 consists of a database management system 205 corresponding to 116 of FIG. 1, and a database 210 corresponding to 118 of FIG. 1, and document store 240 is comprised of a storage media (disk drive, for example) 250 corresponding to 122 of FIG. 1, and a means to access files on the storage media (local filing system or FTP server or equivalent) 260 corresponding to 120 of FIG. 1.

In implementing an SDCMS for the nursing and allied professions, consultation and study of employers in this employment category must be conducted to ideally identify all data of all types needed by all employers throughout the geographical area targeted by the SDCMS. It is likely that some data will be omitted during the development process, but should be incorporated as soon as it is discovered. For purposes of illustration only, much data in both the database tables and document store are not fully identified in this figure. What is described and illustrated is the necessary formatting of these components to meet the requirements for an SDCMS.

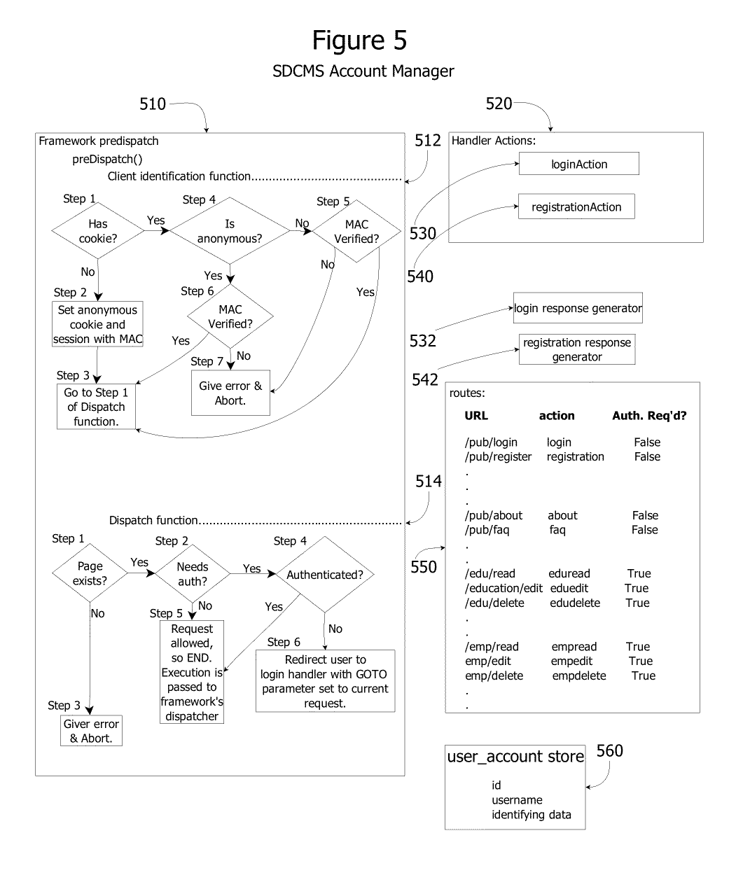

Turning now to the database tables, these should be a set of one or more tables for containing data commonly relevant to hiring decisions in the nursing and allied professions category. Hence, we have an identification table 214 for personal identity information such as, lastname, firstname, middlename, street address, city, county, country, zipcode, phone, and any other information deemed relevant. And we also have an education table 216 to store the names and addresses of all schools and colleges a user has attended with dates of attendance, and degrees/diplomas awarded, and a summary field where a user can describe courses or fields of study pursued. And we have an employment table 218 for storing data concerning employer names, addresses and phone number, dates of employment, job title/occupation, supervisor and supervisor contact information, etc. And we have a licenses_certifications table 220 for storing data concerning all the licenses and certificates obtained by the user, the issuing authority, and expiration date. Note that we also have a documents table 222 for storing information identifying the file name of document files uploaded by users. It should be noted that each of these tables includes a unique id field which for purposes of illustration only has been defined as an auto increment field to avoid ever confusing one record with another in the same table, and a user_id field for storing the value of the id field in the user_accounts store FIG. 5, 560 to ensure that each user's record is clearly linked to him/her and will never be confused with the records belonging to another user. In All tables, the id field should be designated as the primary key of the table.

The above description of a database schema describes one possible embodiment for illustration purposes. The schema may also include specification for table indexes, and the database may be normalized, but any embodiment meeting these minimum requirements is acceptable to qualify as an SDCMS. Note that there is no specification as to exactly or even approximately the proportion or percentage of all data needed by all prospective employers in a targeted geographical area is needed to constitute an SDCMS. An SDCMS can only be judged as “better” than a comparable SDCMS if it includes a larger proportion or percentage of the data needed by prospective employers to make hiring decisions. Thus, if one were to use ONLY the tables defined in FIG. 2, it would meet the criteria to be an SDCMS, but not a very good one because it lacks, among other things, any table(s) for storing data in what in the nursing profession are called “skills checklists.” By including a “skills checklists” table(s), we would have a “better” SDCMS than the one described by FIG. 2.

Document store 240 is simply a directory 252 on one of the server's storage media 250, normally a disk drive. Assuming the path to this directory is //serverrname/drive/storagedirectory, as indicated by 252, then that directory and any number of sub directories within that directory constitutes the physical document store 250. The files stored in this directory need to be identified by referencing the subdirectory path, if any, and the filename stored in said path. For every document file stored in the document store directory, there must be a unique corresponding record in the documents table 222. The documents table 222 requires a user_id field (the value of the id field of the user_accounts database table of FIG. 5, 560) thus identifying each document with the user account it belongs to, and an id field to uniquely identify the document file in the document store, and a filename field and a description field. The filename of the document must also contain the value of the id field. This makes it possible for each record in the documents table 222 to correspond to a unique filename in the document store 240. Thus, a file with the name filename.ext submitted by a user with the id value 12009 will be named 12009_filename.ext in the document store and in the documents table so there will be no confusion as to which user the file belongs to, since there is only one record in the documents table with the id 12009 and the user_id filed value of the same record identifies the one and only one user_account record that the document file belongs to. Any naming system which enforces this unique association of a file in the document store with a record in the documents table will suffice. The document manager component (134 of FIG. 1) will need to access the file and subdirectories in the directory 252 and the interface for such access is provided by 260. If the storage media 250 is located on the same computer as the document manager, then 260 would be the local computer's filing system software, but if the storage media 250 is on another computer, then 260 could be an FTP file server or comparable software.

The data store manager will now be described. CRUD is an acronym that encompasses all database operations needed to create, read, update (edit or change), and delete records in a database table. At a minimum, an SDCMS will require providing users who access their accounts from a client web browser with a user interface (comprised of web pages) allowing them to create new, read, edit, and delete existing records belonging only to their respective user accounts to/from any of the data tables in the data store. The whole of this user interface constitutes the data store manager.

Additionally at a minimum an SDCMS will require providing users who access their accounts from a client web browser with a user interface (comprised of web pages) to view, add and delete documents from the document store. The whole of this interface constitutes the document store manager.

As previously indicated, for illustration purposes only, a full web application software development stack is used. As already explained, all frameworks are equipped with a router or dispatcher which receives all HTTP requests from the Apache HTTP server. The router is designed to analyze each request to determine which handler action the HTTP request should be turned over to for additional processing. A programmer must create a handler action in accordance with the framework's requirements to ensure that the dispatcher or router identifies the request URL with the handler action in order for the router to perform this operation without generating an error. Additionally, frameworks are designed so that handler actions on completion turn program execution over to a response generator (unless programmed to redirect elsewhere), and the response generator must conform to the location and naming conventions employed by the framework for this to properly occur without error.

Those skilled in the art will immediately recognize and appreciate that the above process can be used repeatedly to perform all CRUD operations on all database tables, and to perform the adding, viewing, and deleting of documents to and from the document store.

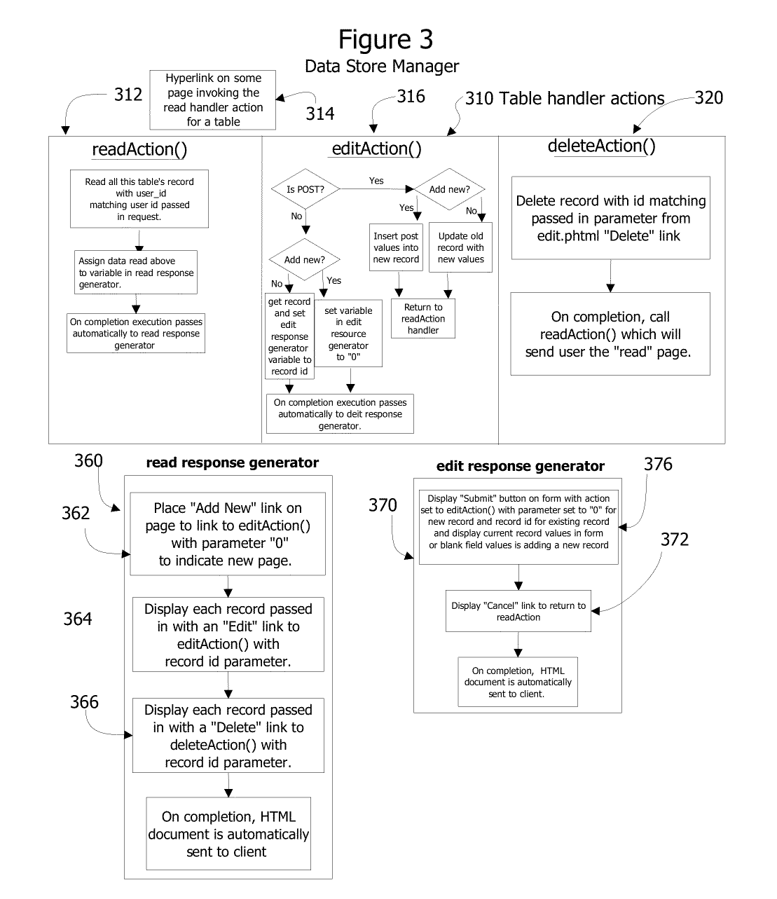

FIG. 3 now shows for illustration purposes only the data store manager. The data store manager must provide the means for a logged in and authenticated user from a web browser on a client computer to perform all CRUD operations on each table and each record of each table in the data store associated with the user's user_account id. FIG. 2 defines the data store to require a user_account id field in all records of every table to associate every record with a unique user_account record. The account manager of FIG. 5 establishes a means whereby every HTTP request submitted by a logged in, authenticated user is identifiable by the value of the user_account table id field associated with the request. Providing the user the means of performing CRUD operations only on his account records using web application technology can be accomplished in many ways. Providing any of these means along with meeting other claims result in an SDCMS, however a certain means of providing all CRUD operations is regarded as the preferred embodiment. In what follows, the variety of means of providing CRUD operations is discussed any of which comply with the requirements for an SDCMS and the preferred means is also defined.

Providing an end user a means of reading all his records in each table can be accomplished by providing a response generator for each table which generates a web page for viewing one record of a table at a time containing hyperlinks to view “next” and “previous” records. This technique is time consuming, but works. The same objective can be achieved by having a response generator for each table providing the user with a web page listing all records on the page, making it quicker and easier for a user to scan and locate a particular record. The preferred embodiment would be to use one response generator for all tables generating a web page divided into sections, one for each table, and each section listing all records of the table. This provides a user interface for quickly viewing and locating all records in all tables and is the preferred embodiment. It may be combined, if desired, with other means described.

Providing an end user a means of creating new records in a table can be accomplished by one or more response generators which yield a menu bar, side bar, or list containing hyperlinks each leading to a response generator for generating a web page containing an HTML form element presenting a blank form where a user can input the field values of a single record for each table. The HTML form's action attribute would be set to invoke a handler action to receive the POST request and create the new record and redirect the user to the page he came from. Another means of creating new records can be to combine a hyperlink on the page(s) used to read records as described above. The preferred embodiment would be to include an “Add New” hyperlink with each table's section of a single page listing all table records in sections. The preferred read page response generator thus serves also as a user's quick and easy access to adding new records to each table.

Existing web application technology to provide a means of updating each record in a table requires a web page listing each table record with an associated “Edit” hyperlink containing a parameter for the value of the id field of the record to a handler action which will fetch from the table the record with the id value passed in and pass control to a response generator to generate a web page with an HTML form displaying the fields of the record and permitting the user to change each and an action attribute set to return the user to a server side routine to update the record in the data store and return the user to the page he came from. So, in essence, any page which lists table records can include such hyperlinks with each record. A single response generator for generating a single web page containing sections for each table and listing the user's records in that table associated with an “Edit” hyperlink as described above is the preferred embodiment.

Providing an end user a means of deleting an individual record requires the same technique used above to provide record update capability—on any page listing a table's records, an associated “Delete” hyperlink associated with the record and leading to a delete handler action which deletes the record and returns the user to the page he came from is needed, and of course the preferred embodiment is to include the “Delete” hyperlinks next to the “Edit” hyperlinks on the one page listing all records in all tables.

Because reading all records in all tables and generating a single page listing all records is a more time consuming process than reading only the records of a single table at a time and generating a web page listing those records, there may be certain circumstances where the one page to read all table records option is too slow. If the code cannot be optimized to improve speed, then the one table at a time read page option would be the preferred embodiment.

To simplify the illustration of creating an SDCMS data store manager as it could be implemented in web application framework, FIG. 3 shows the embodiment discussed above with handler actions to read all records of each table in the data store followed by response generators to generate the web page. FIG. 3 shows a hyperlink 314 which must appear on some web page and must link to a specific table's read handler action or in a preferred embodiment this hyperlink would lead to a single handler action for reading the user's records from all tables for placement on a single read page. FIG. 3 shows an embodiment for illustration only using a single table's handler action 310, containing three handler actions within it the readAction( ) 312, the editAction( ) 316, and the deleteAction( ) 320. Note that a readAction( ) 312 processes the GET request sent via the hyperlink 314 and retrieves all records in the table associated with the table 310 and passes it to its associated response generator 360, which produces a web page containing an HTML hyperlink element 362 to add a new record to the table, and an HTML hyperlink element 364 next to each of the user's records in the table to edit just that record, and a “Delete” hyperlink 366 also next to each record to delete just that record. Note that both the “Add New” 362 and the “Edit” hyperlinks 364 pass program execution to a single handler action, the editAction( ) 316 which serves both to add a new record and edit an existing one. Whether we are adding a new record or editing an existing one is determined by whether or not a value“0” is passed as a parameter in the URL to the editAction( ) 316. A value of “0” indicates a new record is being added, but if not “0”, it represents the value of the id field of the record to edit and that value is used to retrieve the record's data from the table. In either case, the information is passed to the editAction's 316 associated response generator 370 which either displays a blank form, or a form with the data from the record to edit. Note that the response generator 370 will produce a web page containing two hyperlinks, a “Cancel” hyperlink 372, and a “Submit” element 376 for the form data. “Cancel” 372 is a hyperlink back to the readAction( ) 312 permitting the user to abort an add or edit operation. And “Submit” 376 when clicked by the user leads back to the editAction( ) 316 with an HTTP POST request which either saves a new record to the table with the values in the POST request, or updates the edited record with the values of the POST request. Upon completion, editAction( ) 316 redirects execution to the readAction( ) 312 which will re retrieve all the table records, including a newly added or updated existing record and pass the data to response generator 360.

A minimum of three handler actions are needed to accomplish CRUD operations on each table. Hence, in the logically simplest implementation, for the five tables in FIG. 2 we only need 15 handler actions. Since each table requires identical code to achieve CRUD operations with changes required only in table names and table field names, FIG. 2 suffices, therefore, to instruct one skilled in the art how to build the needed handler actions and response generators for the remaining tables to complete the construction of the entire data store manager.

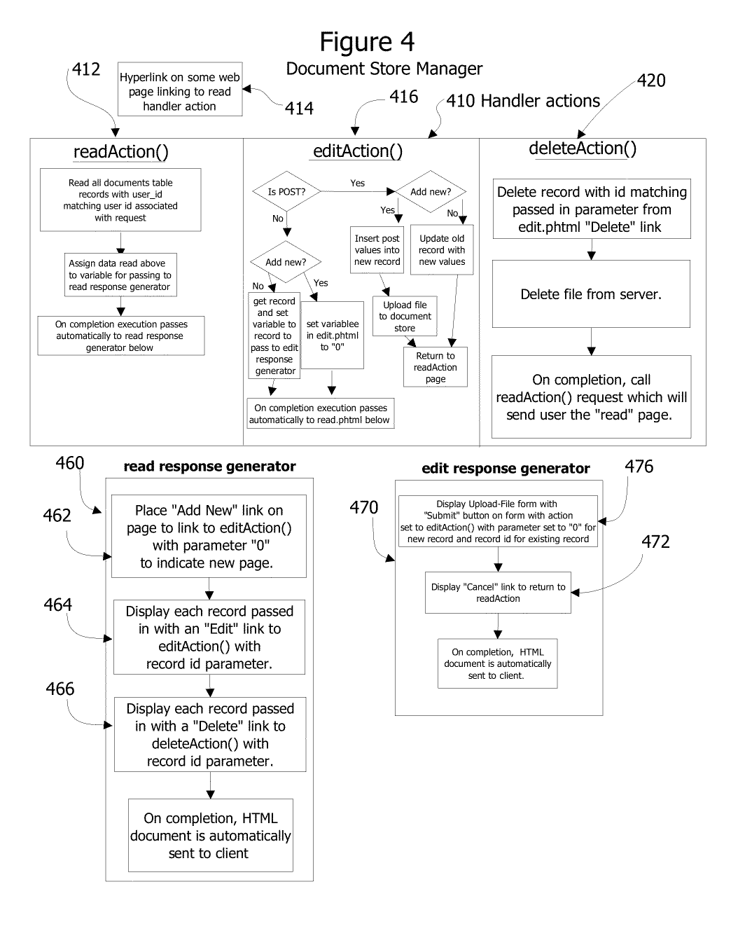

Now the document store manager will be discussed. FIG. 4 illustrates this manager and it should be noted that it differs only slightly from the data store manager of FIG. 3. Note that document store manager has the same named handler actions as the data store manager and that these actions are associated with the same named response generators as are used in the data store manager. The database table associated with these handler actions will of course be the documents table 222 of FIG. 2. There are two fields in this table that are under the control of the user from a client machine—the filename and the description fields. The id field is unique in the table and automatically assigned by the programmer (by use, for example, of the auto increment field property of the database management system), the user_id field of course is the unique id field value assigned to the user upon registration when the user_account table record is created. The developer of an SDCMS document store manager must provide a means whereby each record in the documents table 222 of FIG. 2 corresponds to one and only one file in the document store directory 252 of FIG. 2. There are many ways a developer can achieve this in whatever programming language is used. A very simple method would be to concatenate the id field value of the documents table with the filename provided by a user. Thus, if the unique id value in the documents table is 100590, and the file name provided by the user is anyfile.ext, then the file name stored in the document store directory could be 100590anyfile.ext, or 100590_anyfile.ext, or any other variation. In this manner, a single user or multiple users who upload a file of the same name on their computers will end up having a unique name in the server document store directory. Any method accomplishing a unique file name in the document store which is uniquely associated with a record in the documents table will suffice.

Note that FIG. 4 shows a hyperlink 414 on some web page linking to the read handler action 412. The hyperlink 414 provides access to the document store manager. And note that the readAction( ) 412 is nearly identical to its counterpart in FIG. 3, 312. And so is the read response generator 460 associated with it. 412 and 460 together produce a web page listing the filename and description fields of each record in the documents table with an “Edit” hyperlink 464 which passes the record id to the editAction( ) 416 and a “Delete” hyperlink next to it which passes the record id to the deleteAction( ) 420. The web page produced will also have an “Add New” link 462 passing the value “0” to the editAction( ) 416 to signal that a blank upload-file form will be displayed.

Note that the editAction( ) 416 is nearly identical to its counterpart 316 in FIG. 3. The only difference is that 416 now includes a step to upload the file from the client computer to the server (during which time, of course, the filename will be modified to uniquely correspond to the new record added to the documents table as discussed above). This step appears after the new record is added.

Note that there is also minor differences between edit response generator 470 compared to 370 of FIG. 3. The difference is that the HTML form element used is an upload-file form requiring the programmer to develop code to upload the designated file from the client computer to the server directory 252 of FIG. 2, and of course changing the name in the process to maintain correspondence between the file and its record in the documents table.

Note also that the deleteAction( ) 420 is patterned after the corresponding action 370 of FIG. 3. The difference is that 420 requires the additional step of deleting the file from the server corresponding to the record being deleted from the documents table.

Now the SDCMS account manager will be described.

The means of safeguarding user account data from being viewed or modified by others is provided by the account manager component corresponding to FIG. 5.

At present, the most common practice for safeguarding user data on web sites is to require users to register (create a user account) with a unique username and a password or other identifying data. As long as the user keeps the password or other identifying data a secret, user data is safe except from various hacking techniques. In recent years, client side devices for substituting fingerprint, iris and retinal eye scans, palm prints, or voice for passwords have been developed for use in various industries and fingerprinting devices for use with client computers to identify users at the client in web applications are already available. Fingerprinting and other devices to replace or provide an alternative to passwords of course are accompanied by software for both the client and server along with detailed programming instructions to interface with a web application. It is intended that an SDCMS may use any of these alternatives to passwords as they become available. Therefore, we define the basis of web application security to be a unique username coupled or associated with any identifying data (password, fingerprint, iris scan, etc.). Identifying data may be stored along with the username in the filed of a record in a database table, or it may be stored on a separate third-party server where the association with the username must be maintained. Therefore, the term identifying data matching is used to refer to the process of comparing two sets of identifying data to determine if they are considered a match. And the term identifying data store is used to designate where the identifying data is stored, it being understood that a means of coupling or association between username and identifying data is maintained. The term user_account store is defined here to include a user_accounts database table comprising a unique id field (which can be provided via the database management systems auto increment feature), a username field, and identifying data 665 (password, fingerprint, etc.) where identifying data, if not stored in a field of the user_accounts table, must be stored in a location accessible to the SDCMS and coupled or associated with the username field or the id field of the user_accounts table. A user account is nothing more nor less than a record in the user_accounts table, comprising a unique id, a unique username, and a password or other identifying data.

The following web application framework program modules are needed: a predispatcher 510, and two handler actions, a login handler (named loginAction) 530 and a registration handler (named registrationAction) 540, a user_accounts store 560, and an access control module 550. The login handler 530 requires a login response generator 532. And the registration handler 540 requires a registration response generator 542. As with most web sites providing user data safeguarding, some pages of an SDCMS must be accessible to the general public (at least a login and a registration page). Any number of web pages as desired associated with handler actions can be included in an SDCMS for public viewing. Often such pages will explain the goals, objectives, or purposes of the web site and offer contact information to those interested, and a Frequently Asked Questions page. Therefore, though not necessary, one may additionally include handler actions associated with response generators for an “About,” a “FAQ,” and a “Contact Us” page and any others desired. Therefore to control access (means (2) above), a module is needed which associates each handler action with a specific, unique request URL in the entire SDCMS site and a value indicating if the URL's corresponding web page is accessible to the public or to just authenticated clients with records in the user_accounts table. For purposes of this discussion we will name this module “routes” as indicated by 550. This module can be in any format. It could be a text file, a database table, a class module, or any other computer readable means by which a programmer can associate a request URL to a handler action with a value indicating if the page can be sent to anyone, or to just authenticated users.

The predispatcher 510 is the heart and work horse of the account manager. It must initially perform the client identification function 512. It is here that client tracking (sending a session cookie with at least a session id, and setting up a server side session with the same id, and assigning authentication status of the session) is implemented. In Step 1 of said function, it is determined if the HTTP request is accompanied by a cookie. If not, Step 2 sends to the client an unauthenticated (anonymous) cookie with an encrypted session id, creates a session object where the session id is stored, and saves the MAC of the encrypted cookie. Step 3 then proceeds to Step 1 of the dispatch function 514. If the request is accompanied by a cookie, Step 4 determines if it is an unauthenticated cookie. If so, Step 6 attempts to verify it with the stored MAC value. If not verified, Step 7 gives the user an error and aborts without showing the user any page. If verified, program control is passed to Step 1 of the dispatch function. If step 4 determines that the cookie is not anonymous, it must therefore be authenticated and Step 5 attempts to verify it. If not verified, Step 7 gives user an error and aborts. If verified, program execution is passed to Step 3 which passes control to Step 1 of dispatch.

Step 1 of the dispatch function 514 determines if the requested URL exists by looking it up in routes 550. If it doesn't exist, Step 3 sends the client an error message and aborts. If the action does exist, Step 2 determines if it requires authentication. If authentication is required, Step 4 determines if the accompanying session is authenticated. If so, Step 5 allows the request and the dispatch function is ended and program control is automatically passed to the frameworks dispatcher which will pass the request on to the handler action associated with the request URL where the web page is prepared and sent. But if Step 4 determines the session is not authenticated, in Step 6 the user is redirected to the loginAction with the original request URL attached as a GOTO parameter. Back in Step 2, if authentication to view the page is not required, program execution is passed to Step 5 which allows the request to be sent to the freamework's dispatcher resulting in the web page requested being generated as the response.

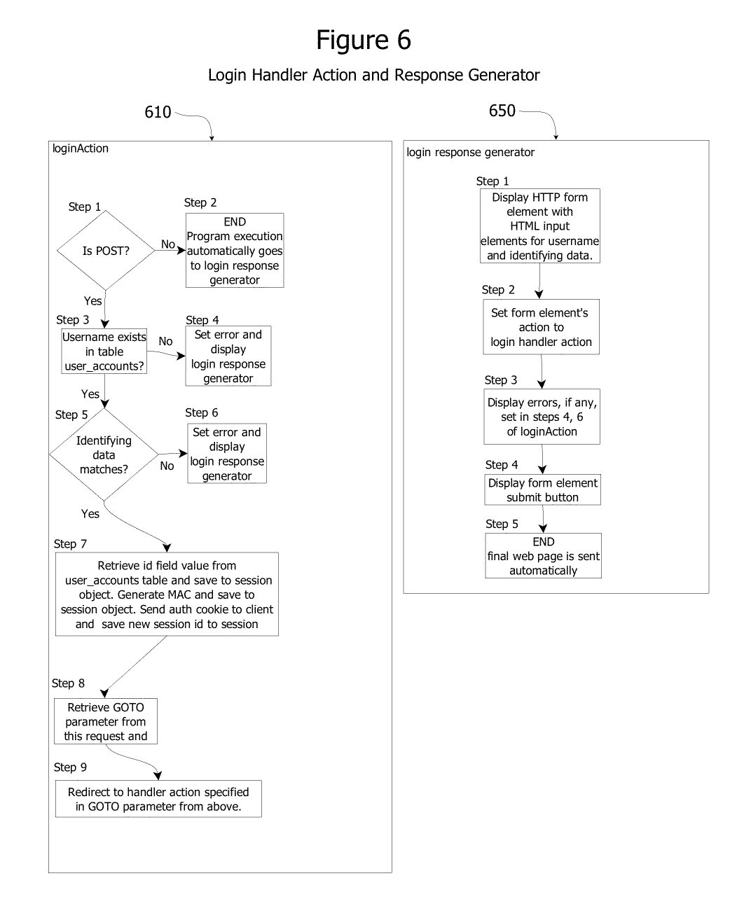

FIG. 6 shows details of the loginAction 610 corresponding to FIG. 5, 530 and the corresponding login response generator 650 corresponding to FIG. 5, 532. Regarding loginAction 610, Step 1 determines if the request received is a GET request, as would be the case when the request is sent via the dispatch method FIG. 5, 514, and Step 2 merely turns program execution over to login response generator 650. If the request received by loginAction 610 is an HTTP Post request, Step 3 and Step 5 check that the username and identification data provided by the user for a match with the user_account store (FIG. 5, 560). If authenticated (i.e., the username is found and the identification data matches) Step 7 sends the client an authenticated cookie replacing the unauthenticatd cookie, generates an MAC and saves it to the session object, then retrieves the id field value of the user account record and saves it to the session object, and Step 8 retrieves from the request the GOTO parameter (the original request submitted from the client before the dispatch method FIG. 5, 514), and Step 9 then invokes the handler action corresponding to the original request. Back in Step 3, if the user name is not found in the user_accounts table, Step 4 sets an error message and invokes login response generator again displaying the error for the user to correct and resubmit, and in Step 5, if the identifying data 733 (password or biometric scan) does not match, Step 6 sets an error message and invokes the login response generator again displaying the error for the user to correct and resubmit.

Now the login response generator 650 is described. Step 1 displays an HTML form element with input elements for username and identifying data (password, fingerprint scan, or other). Step 2 then sets the form elements action property to the URL associated with the login handler action. Step 3 then displays any error from a previous submit as set in steps 4 and 6 of loginAction 610. Step 4 displays the form element's (from Step 1) submit button. And Step 5 ends and program execution automatically turns the web page created over to the HTTP server to transmit back to the client.

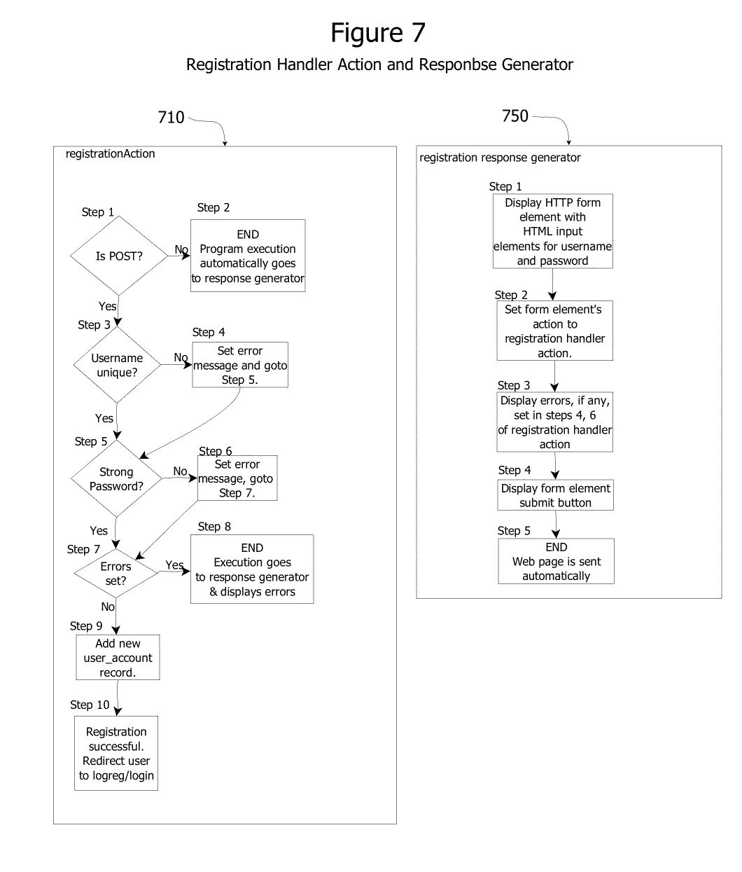

FIG. 7 depicts the registration handler action 710 corresponding to FIGS. 5, 540 and the registration response generator 750 corresponding to FIG. 5, 542. Step 1 of registrationAction 710 checks to see if the request is a POST and if not automatically passes program execution to registration response generator 750 which results in the client being sent a web page showing a blank registration form with no errors for the client user to fill out and submit.

If Step 1 determines it is a POST, Step 3 then determines if the user name supplied is unique in the database user_accounts table of FIG. 5, 560 and if not, Step 4 sets an error message and proceeds to Step 5 which checks the identification data (password which would require another input element, or other means of receiving identification data). If the identification data does not match, Step 6 sets an error message and passes program execution to Step 7. Step 7 determines if any errors are set and if so, Step 8 passes execution to registration response generator 750 which displays the errors and the original username requiring the user at the client to resubmit the form with errors corrected.

If no errors are detected in Step 7, program execution is passed to Step 9 which adds a new user_account record to the table and saves the identifying data as required and passes control to Step 10 which directs the user to the login handler action described in FIG. 6.

Now the registration response generator 750 is described. Step 1 displays an HTML form element with an input element for username and identification data (password which would require another input element, or other means of receiving identification data), Step 2 then sets the form elements action property to the login handler action. Step 3 then displays any error from a previous submit as set in steps 4 and 6 of registrationAction 710. Step 4 displays the form element's (from Step 1) submit button. And Step 5 ends the registration response generator and program execution automatically turns the web page created over to the HTTP server to transmit back to the client.

Now the output manager will be described. The intent or goal of the SDCMS output manager is to provide a web application interface to users of client computers with access to user accounts for selecting employment related document types in a digital document format, said employment related document types being defined as documents which are deemed relevant for employers or hiring agents in an occupation or category which may include but not be limited to resumes, job applications, IRS forms (I-9, and W-4 or others), tests, skills checklists, oaths, and sworn statements, and standard employment agreements such as permissions for background checks, credit checks and reference checks, and drug policy agreements. Note that this definition does not specify any particular proportion or percentage of all targeted employers or hiring agents to whom said variety of digital files must be acceptable. Variations in the proportion or percentage only determine how good an SDCMS embodiment is in this respect.

In a preferred embodiment, the SDCMS output manager would include at least one of the several standard resume formats and at least one of several job application formats. It would also permit resumes and applications to be prepared in at least one of the several widely used digital document formats, such as Adobe Systems Portable Document Format (PDF), and Microsoft Word document formats (doc and docx), and Hypertext Markup Language (HTML) format which permits resumes and applications to be prepared as web pages for viewing using web browsers which can also be printed out. It should also include data and document files in Extensible Markup Language (XML) format as this language has become a major standard throughout the computer world as the computer readable format of choice for transmitted digital information making it possible for recipients to, for example, use automated computer programming functions to format the XML data into any number of different reports, such as resumes, applications, and in different formats (PDF, doc or docx, and HTML, etc.). XML also provides a convenient mechanism to bundle multiple binary documents (digital video, audio, and image files, etc.) into a single file and to associate any other data (descriptions, dates, sources, author names, or any other metadata) with each of these files. As stated earlier, many employers or agents are currently using one or another Applicant Tracking System (ATS) and providing these employers or agents with data in XML format may be desirable to them for importing the data into their ATS.

A preferred embodiment of the SDCMS output manager would also include interfaces for collecting and reporting a number of other data items not collected and stored in the data or document stores, including, for example, digital signatures, willingness to submit to drug testing, to take lie detector tests, or answers to questions regarding criminal background, or sworn statements of any description, or any other data enhancing the usefulness of the SDCMS.

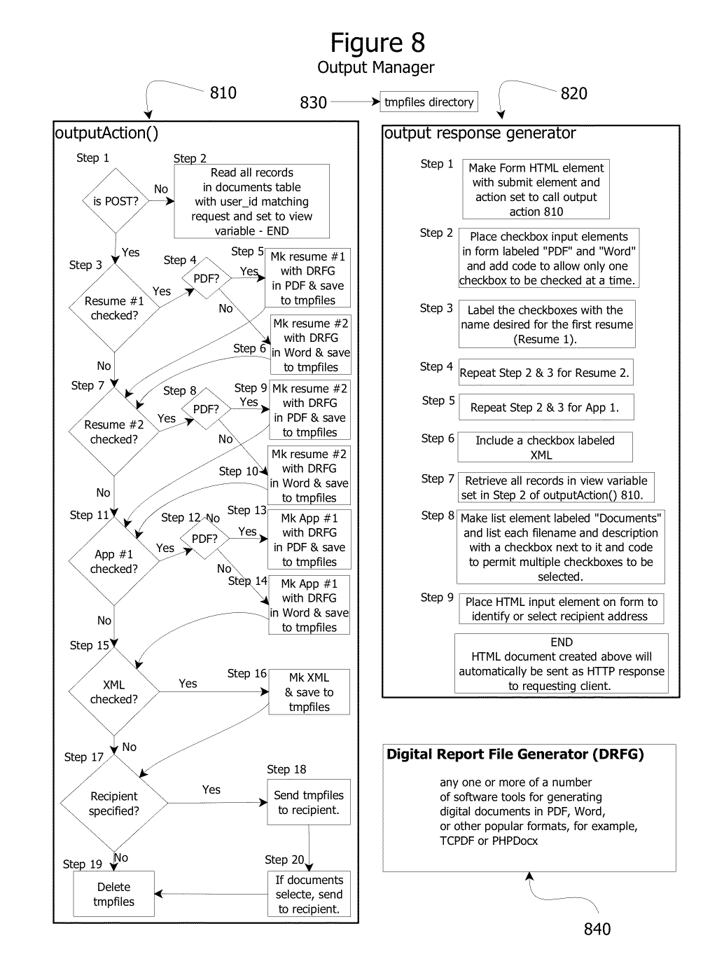

FIG. 8 illustrates the essential steps in making a preferred embodiment of an output manager as it would be implemented using a full web application development framework. For illustration only, it demonstrates the construction of an output manager that can generate two resume formats (named Resume #1 and Resume #2), one job application format (named Application #1) and each of these documents can be generated as PDF or Microsoft Word documents. Additionally, an XML formatted document can be produced for presenting data store table records pertaining to a specific user.

Note that the output manager is implemented as a single handler action and corresponding response generator. But also note that it could just as well be implemented as a set of multiple handlers. Combining all functions into a single page generator provides the end user of a client computer with a single interface to perform all output functions or just one or a few, depending on the selections made. 810 represents the output handler action which has been named outputAction( ) and 820 represents the action's associated response generator. Step 1 of checks the HTTP request received to determine if it is a POST or not. If not a post, step 2 reads all records from the documents table FIG. 2, 212 associated with the user submitting the request and saves them to a variable for passing to the output response generator and ends so that execution is passed automatically to the response generator. If step 1 is a POST, step 2 checks to see if resume #1 has been selected. If so, step 4 determines if the PDF checkbox is checked, and if so proceeds to step 5 which prepares resume #1 in PDF format using a digital report file generator (DRFG) 840 and saves it to a tmpfiles directory 830 on the server. If the PDF checkbox in step 4 was not selected, then step 6 using DRFG 840 prepares resume #1 as a Word document using and saves it to the tmpfiles directory. Both step 5 and step 6 on completion pass program control to step 7. Step 7 through 10 perform exactly as step 3 through step 6 except for resume #2. And steps 9 and 10 both pass program control to step 11 when completed. Steps 11-14 also perform exactly as steps 3-6 except for application #1, and steps 13 and 14 pass program control to step 15 on completion. Step 15 determines if data is to be sent in XML format and if so step 16 prepares the XML file and saves it to the tmpfiles directory 830, and step 16 passes program control to step 17. Step 17 determines if a recipient has been specified, said recipient being the user requesting download or the email address or FTP site or other electronic transmission destination. If so, step 18 sends all files, if any, from the tmpfiles directory to the recipient address and proceeds to step 20 which sends each selected document (from step 9 of the output response generator 820) to the recipient. Step 19 receives program control from step 17 if a recipient was not specified and from step 20 and deletes all files in the tmpfiles directory.

Output response generator 820 receives program control from outputAction( ) 810 if outputAction( ) receives a non POST HTTP request. The output response generator presents the client with the web page for the end user to make selections as to what reports in what formats and what documents to include with those reports. In step 1, the programmer creates an HTML form element with a submit button and sets the form's action attribute to return to outputAction( ) with the form's data as a POST request. In step 2, the programmer places HTML checkbox elements named “PDF” and “Word” and adds code to permit only one of the checkboxes to be selected at a time. In step 3 a header is placed above the checkboxes of step 2 with a checkbox and the name to be used for Resume #1. Steps 4 and 5 both repeat actions of steps 2 & 3 for the name used for Resume#2 and the Application #1 respectively. Step 7 retrieves the records passed via step 2 of 810, and step 8 creates an HTML list element containing the names and description and a checkbox for each record and includes code to permit multiple checkboxes to be selected in the list. And step 9 adds an HTML input element for the user to enter the recipient address to receive the reports and documents. When the user clicks the submit button of the form added in step 1, his selections on the form are passed back to the outputAction( ) 810 as a POST request.

Steps 5, 6, 9, 10, 13, 14, and 16 of FIG. 8, 810, outputAction( ) need further explanation. These steps all involve the making of documents in different formats—PDF, Word, and XML. Each of these requires a digital report file generator 840. Although each of these steps involves a large amount of programming and a detailed understanding of the document formats involved (PDF, Word, and XML,) there are software tools available that make these steps straightforward and easy, though time consuming. For example, there is an open source PHP library, TCPDF available at http://www.tcpdf.org/, permitting users to create custom PDF files. This library can be installed with the web application framework. The process of creating resumes and applications in PDF format is then a simple matter of creating a PHP code module which reads the records from the data store tables described in FIG. 2 pertaining to a specific user id and then using the TCPDF library commands to format the resume or application as desired incorporating the data. TCPDF is distributed with over 100 sample documents to instruct users how to use all the features of TCPDF. The result is a single program module, a digital report file generator, for generating a specific formatted resume or application file in PDF format which can then be downloaded by the client. There are also similar libraries for preparing Microsoft Word documents using PHP, such as PHPDocX at http://www.phpdocx.com.

Using a framework language to read data from database tables and put the data into an XML file is a simple process most web developers are quite familiar with and should need no further illustration.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A system enabling unauthenticated users, defined as users not having a user account or users having a user account but not yet logged in, to establish user accounts and enabling authenticated users, defined as users having a user account and having logged in, to exclusively manage data and documents relevant to their employability in one or more occupations or categories of related occupations and to generate one or more standard reports used in applying for job openings in said occupations or categories of related occupations, said system including a network server in communication with client systems, the system comprising the following components for each occupation or occupational category included in said system, said components accessible to client systems via said network server: a data store, a document store, an account manager, a data store manager, a document store manager, and an output manager for generating reports using programmatic digital document generators.

2. The system of claim 1, wherein said client systems include computer processing devices operated by users.

3. The data store of claim 1 comprising a set of one or more database tables, each of said tables comprising one or more columns for each type of data such as personal data, work history, education, skills, licenses, certifications, etc. identified as relevant to prospective employers or agents for making hiring decisions in one or more specific occupations or category of related occupations, and a column for containing the value of the unique user id column from the user accounts table of claim 5 to differentiate records of one user account records from all others, and a column for a unique id identifying each record in said each data table.

4. The document store of claim 1 comprising a directory on a server file system storage media for storing employment related documents, said employment related documents being assigned a unique name being a concatenation of the name of the file and the id field value of the user accounts table of claim 5, and a documents table (which can be in the same database as the data store tables) comprising a field for a unique id value for each record, a field for storing the value of the id field of the user accounts table of claim 5 to differentiate one user account's documents from all others, a field for storing the file name of the document, and a field for storing a description of the file.

5. The account manager of claim 1 comprising a set of user accounts of claim 1 each comprising a record in a user accounts database table comprising a column for a unique user id, and a column for containing a user password or for referencing the location of other identification data in accordance with instructions for an identification data input device connected to a client associated with said user id, and a column for a unique username associated with the unique user id, wherein said account manager intercepts all client requests and assigns an unauthenticated user status to all users who have not logged in, provides a user registration interface permitting a user to establish a user account, and provides a user login interface requiring a user to provide a username and identifying data (password or other) to determine if the user account table contains a matching user account record bearing the same username and the same identifying data and, if so, assigns an authenticated user status to the user, and if not, retains the unauthenticated user status, tracks authenticated and unauthenticated users, and ensures only authenticated users can gain access to only data and documents associated with the user account record of the authenticated user.

6. The data store manager of claim 1 comprising a user interface for an authenticated user to perform all CRUD operations on the records associated with the authenticated user's user account of each data store table of claim 2.

7. The document store manager of claim 1 comprising a user interface for an authenticated user to perform the addition, deletion, and editing of information and documents associated with the authenticated user's user account in the document store of claim 4.

8. The output manager of claim 1 comprising one or more digital report file generators to generate employment related document types in a digital document format, said employment related document types being defined as documents which are deemed relevant for employers or hiring agents in an occupation or category including but not limited to resumes, job applications, IRS forms (I-9, and W-4 or others), tests, skills checklists, oaths, and sworn statements, and said digital document formats comprising, for example, Adobe Portable Document Format, Microsoft Word document format, XML format, HTML format or any other as deemed relevant, said report file generators using an existing or an inventor developed set of program libraries designed for generating said digital document formats installed on the server of claim 1, and a user interface permitting authenticated users to select one or more of said employment related document types in a digital document format, and to select one or more documents from the document store of claim 4, and to select or specify for said documents a destination for said documents to be electronically transmitted, said destination including but not limited to the user's current client computer (as downloads), an email address to which an email message with the documents attached can be transmitted, an FTP upload site, or other electronic transmission destination specification.
